(19) United States
(12) Patent Application Publication
(10) Pub. No.: US 2023/0382219 A1
(43) Pub. Date: Nov. 30, 2023

(54) ELECTRICALLY OPERABLE DRIVE TRAIN AND VEHICLE

(71) Applicant: ZF Friedrichshafen AG, Friedrichshafen (DE)

(72) Inventors: Andreas Pfeffer, Viechtach (DE); Franz Reitinger, Esternberg (AT); Alexander Mühlbauer, Windorf (DE); Tobias Brilka, Iggensbach (DE)

(73) Assignee: ZF Friedrichshafen AG, Friedrichshafen (DE)

(21) Appl. No.: 18/324,383

(22) Filed: May 26, 2023

(30) Foreign Application Priority Data
May 30, 2022 (DE) 10 2022 205 334.6

(51) Int. Cl. B60K 17/04; B60K 1/02; B60K 17/28

(52) U.S. Cl. CPC B60K 17/04; B60K 1/02; B60K 17/28

(57) ABSTRACT

Disclosed is an electrically operable drive train (10), having a first transfer case (11), a first electric motor (12), and a first axle (13, 13′) as well as a second transfer case (14), a second electric motor (15, 15), and a second axle (16, 16′). The first transfer case (11) has a first input (17), a first axle output (18), and a first coupling output (19). The second transfer case (14) has a second input (20), a second axle output (21), and a second coupling output (22). The first coupling output (19) can be coupled with the second coupling output (22) by way of a coupling shaft (23). The drive train (10) according to the invention is distinguished in that the first transfer case (11) further has a first power take-off (24). The invention relates further to a corresponding vehicle.

### RELATED APPLICATIONS

This application claims the benefit of and right of priority under 35 U.S.C. § 119 to German Patent Application no. DE 10 2022 205 334.6, filed on 30 May 2022, the contents of which are incorporated herein by reference in its entirety.

### FIELD OF THE DISCLOSURE

The present invention relates to vehicle drive trains, particularly to an electrically operable drive train and to a corresponding vehicle.

### BACKGROUND

Different types of electrically driven utility vehicles, such as, for example, wheeled loaders, trucks, mining vehicles or vehicles used at airports for baggage handling, are already known in the prior art. Such electrically driven utility vehicles are either driven purely electrically, that is to say they have only an electric battery or an electric accumulator for supplying them with energy, or they are driven diesel-electrically, which means that the required energy is provided by a diesel-powered generator, usually in conjunction with an electric buffer store, such as, for example, a correspondingly dimensioned capacitor. In all cases, the mechanical power required for the travel drive or the working drive is provided by one or more electric motors.

In this context, DE 10 133 815 A1 discloses a drivable aircraft loading apparatus having a frame, a main platform displaceable vertically relative to the frame, and a front platform displaceable vertically relative to the frame and dockable with the aircraft and power means for independently lifting and lowering the platforms. The aircraft loading apparatus of DE 10 133 815 A1 has an electric drive.

DE 20 2016 066 076 U1 discloses a trailer for an electrically operated truck having at least one recess for holding in each case one or more battery packs.

DE 10 2018 206 411 A1 discloses a drive train for a working machine which has a front axle having an electric front axle drive unit and a rear axle having an electric rear axle drive unit. The drive train further has a switchable coupling which can connect the front axle drive unit in a driving manner to the rear axle drive unit.

### SUMMARY

The known electrically operable drive trains are, however, disadvantageous in that the different electric motors are provided solely for the propulsion of the working machine or vehicle, even if in some situations only one of the electric motors is required for propulsion.

It is an object of the invention to propose an improved electrically operable drive train.

This object is achieved according to the invention by the electrically operable drive train as disclosed herein. Advantageous embodiments and developments of the invention will be apparent in light of the present disclosure.

The invention relates to an electrically operable drive train, comprising a first transfer case, a first electric motor and a first axle as well as a second transfer case, a second electric motor and a second axle, wherein the first transfer case has a first input, a first axle output and a first coupling output, wherein the second transfer case has a second input, a second axle output and a second coupling output, and wherein the first coupling output can be coupled with the second coupling output by way of a coupling shaft. The drive train according to the invention is distinguished in that the first transfer case further has a first power take-off.

The invention thus describes an electrically operable drive train. The drive train is configured in particular to drive an all-terrain working machine, an all-terrain special vehicle, such as, for example, a crane or wheeled armored vehicle, or an all-wheel drive truck, which means that it must be designed for long-term use with very high power compared to passenger car operation or even truck operation. An electric drive train of a passenger car, for example, would not be suitable for this purpose.

The drive train according to the invention comprises a first transfer case with which there are associated a first electric motor and a first axle. The first electric motor provides a torque and a speed which can be passed into the first transfer case by way of the first input and which are converted by the first transfer case so that they can be transmitted further to the first axle by way of the first axle output for driving the first axle.

The drive train according to the invention further comprises a second transfer case with which there are associated a second electric motor and a second axle. The second electric motor also provides a torque and a speed which can be passed into the second transfer case by way of the second input and which are converted by the second transfer case so that they can be transmitted further to the second axle for driving the second axle.

In addition, the first transfer case and the second transfer case each have a coupling output. The first coupling output of the first transfer case can be coupled with the coupling shaft, as can the second coupling output of the second transfer case. Thus, a drive connection can be produced between the first transfer case and the second transfer case by way of the coupling shaft in the coupled state. This allows, for example, drive power to be transmitted from the first electric motor to the second axle or from the second electric motor to the first axle. If drive power is to be transmitted from the first electric motor to the second axle, the first axle is advantageously locked. Conversely, the second axle is advantageously locked if drive power is to be transmitted from the second electric motor to the first axle. Thus, by way of the first and second coupling outputs and the coupling shaft, full and in particular lockable all-wheel drive can be provided. If slip occurs at one of the two axles, the drive power of the associated electric motor can nevertheless be used for propulsion in that the corresponding axle is locked, so that the drive power is transmitted to the axle that is not experiencing any slip. Since the drive power of the first and second electric motors can thus be coupled, it is advantageously possible to dispense with the use of two correspondingly more powerful, heavier and more expensive electric motors, each of which could also individually provide the maximum drive power.

According to the invention, it is provided that the first transfer case further has a first power take-off. The drive train according to the invention thus differs from drive trains of the type in question known from the prior art in that the first transfer case with the first electric motor associated therewith not only drives the first axle but in addition can also drive a power take-off. The first electric motor can thus drive both the first axle and the first power take-off, which gives rise to the advantage that—compared to the prior art—an additional electric motor for driving a power take-off does not have to be provided. For example, the first electric motor can drive the first axle and the first power take-off at the same time or, depending on the situation or in accordance with a corresponding driver command, can drive only the first power take-off or only the first axle. If the first electric motor drives only the first power take-off, the power take-off can be operated wholly independently of the speed. The second electric motor, meanwhile, can drive the second axle, for example, and thus provide the required propulsion for forward movement of the vehicle.

When a vehicle having the drive train according to the invention is stationary, the power take-off can thus be operated wholly independently of the driving operation. Likewise, the power take-off can be operated independently of the travel drive whenever the second electric motor alone is able to provide sufficient drive power for the driving operation. If, however, the first electric motor is required for the driving operation in addition to the second electric motor, then the power take-off can be operated only at a motor speed of the first electric motor given by the driving operation.

The first and second transfer cases are thus at least functionally identical but in particular even wholly structurally identical, that is to say the first and second transfer cases are structurally identical transmissions.

The first and second transfer cases are preferably each in the form of a switchable and at least two-stage transmission, so that, as required, a suitable transformation of the torque provided by the first or second electric motor and passed into the transmission and of the speed provided by the first or second electric motor and passed into the transmission can be adjusted.

Preferably, the first and second transfer cases are each in the form of a spur gear drive.

The first and second electric motors can likewise be structurally identical electric motors.

The first and second electric motors can each be in the form of a synchronous or asynchronous machine, in particular in the form of three-phase synchronous or three-phase asynchronous machines.

The first and second electric motors advantageously each have an associated inverter which converts the electric direct current, which is preferably provided by an electric battery, into alternating current suitable for activating or operating the first or second electric motor.

The first axle can, for example, advantageously be in the form of a steerable driven axle, and the second axle can be in the form of, for example, a non-steerable driven axle. Likewise, it is also possible, conversely, for the second axle to be in the form of a steerable driven axle and the first axle to be in the form of a non-steerable driven axle.

According to a preferred embodiment of the invention, it is provided that the first axle output can be coupled with the first electric motor by way of a first axle output coupling element, that the first power take-off can be coupled with the first electric motor by way of a first power take-off coupling element, that the first coupling output can be coupled with the first electric motor by way of a first coupling output coupling element, that the second axle output can be coupled with the second electric motor by way of a second axle output coupling element, and that the second coupling output can be coupled with the second electric motor by way of a second coupling output coupling element. Thus, the mentioned elements can, as required, be connected in a driving manner to the first or second electric motor and uncoupled again. Advantageously, each of the mentioned elements additionally has an associated brake for stopping the element in question and avoiding undesirable, optionally creeping rotation. In particular, the coupling shaft can also be stopped completely by being uncoupled both from the first electric motor and from the second electric motor, so that it does not generate any drag torque during driving operation.

According to a further preferred embodiment of the invention, it is provided that the second transfer case further has a second power take-off, wherein the second power take-off can be coupled with the second electric motor by way of a second power take-off coupling element. Thus, with the second power take-off, a further power take-off is available which can be used in addition or alternatively to the first power take-off and in an analogous manner to the first power take-off.

According to a particularly preferred embodiment of the invention, it is provided that the first coupling output coupling element is arranged in the first transfer case and the second coupling output coupling element is arranged in the second transfer case. Arrangement in the first or second transfer case is understood as meaning that the first coupling output coupling element is housed by a housing of the first transfer case and that the second coupling output coupling element is housed by a housing of the second transfer case. This gives rise to the advantage that no further coupling elements have to be provided with their own housing. Installation space can thus be saved.

According to a further preferred embodiment of the invention, it is provided that the first axle output and the first coupling output have an identical speed reduction relative to the first input and that the second axle output and the second coupling output have the same identical speed reduction relative to the second input. This simplifies the construction of the transfer cases as well as the transmission of drive power between the first transfer case and the second transfer case equally.

According to a further preferred embodiment of the invention, it is provided that the first transfer case has a plurality of associated first axles. To that end, the first axles advantageously have a through-drive, so that the drive power can be distributed to all the first axles. The through-drives of the individual axles can advantageously also have associated locks, in order to lock one or more through-drives. All the first axles are supplied with drive power by the first electric motor by way of the first transfer case.

According to a further preferred embodiment of the invention, it is provided that the second transfer case has a plurality of associated second axles. The second axles also advantageously have a through-drive, so that the drive power of the second electric motor can correspondingly be distributed to all the second axles. The through-drives of the second axles can advantageously also have associated locks, in order to lock one or more through-drives. All the second axles are supplied with drive power by the second electric motor by way of the second transfer case.

According to a further preferred embodiment of the invention, it is provided that the first power take-off is connected in a driving manner to an additional first electric motor. In this case, the first power take-off is thus used as an additional input by way of which the additional first electric motor can pass additional drive power into the first transfer case. Thus, in a simple manner, the drive power which can be provided by way of the first transfer case can be increased.

According to a further preferred embodiment of the invention, it is provided that the second power take-off is connected in a driving manner to an additional second electric motor. Like the first power take-off, the second power take-off can additionally or alternatively also be connected in a driving manner to an additional second electric motor. The drive power which can be provided by way of the second transfer case can thereby correspondingly be increased.

The invention relates further to a vehicle comprising a drive train according to the invention. The advantages already described also follow therefrom for the vehicle according to the invention.

The vehicle is preferably an all-terrain working machine, a crane, an all-wheel drive truck, a wheeled armored vehicle or an all-terrain special vehicle.

In particular, it is provided that the working machine is in the form of a wheeled loader, a dumper, a digger, a telescopic loader or a tractor.

### BRIEF DESCRIPTION OF THE DRAWINGS

The invention will be explained by way of example hereinbelow with reference to embodiments shown in the figures, in which:

FIG. 1 shows by way of example and schematically a possible embodiment of an electrically operable drive train according to the invention,

FIG. 2 shows by way of example and schematically a further possible embodiment of an electrically operable drive train according to the invention, and

FIG. 3 shows by way of example and schematically yet a further possible embodiment of an electrically operable drive train according to the invention.

Identical objects, functional units and comparable components are designated by the same reference signs throughout the figures. These objects, functional units and comparable components are of identical design in respect of their technical features, unless otherwise apparent explicitly or implicitly from the description.

### DETAILED DESCRIPTION

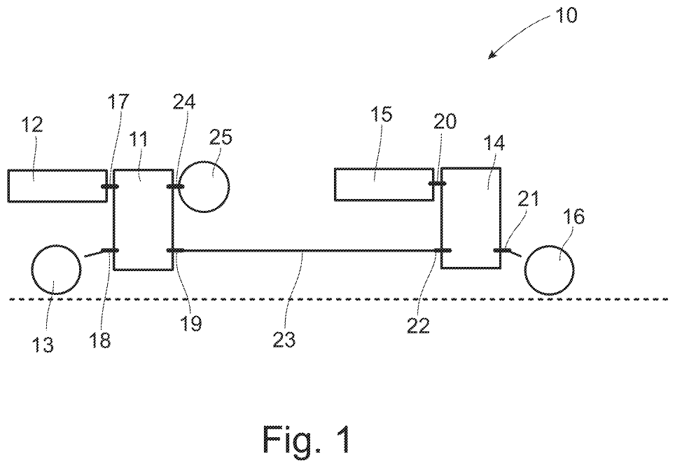

FIG. 1 shows by way of example and schematically a possible embodiment of an electrically operable drive train 10 according to the invention. The drive train 10 comprises a first transfer case 11, a first electric motor 12 and a first axle 13 as well as a second transfer case 14, a second electric motor 15 and a second axle 16.

The first transfer case has a first input 17, a first axle output 18 and a first coupling output 19. The second transfer case 14 correspondingly has a second input 20, a second axle output 21 and a second coupling output 22. The first coupling output 19 and the second coupling output 22 are coupled by way of a coupling shaft 23.

As can further be seen, the first transfer case 11 has a first power take-off 24 by way of which, according to the example, a mechanical secondary consumer 25 is driven.

The first transfer case 11 allows the first axle output 18 to be coupled with or uncoupled from the first electric motor 12 by way of a first axle output coupling element (not shown in FIG. 1). The first transfer case 11 likewise allows the first power take-off 24 to be coupled with or uncoupled from the first electric motor 12 by way of a first power take-off coupling element (not shown in FIG. 1) and allows the first coupling output 19 to be coupled with or uncoupled from the first electric motor 12 by way of a first coupling output coupling element (not shown in FIG. 1). The first coupling output coupling element is arranged, according to the example, in the housing of the first transfer case 11.

According to the example, the first axle output 18 and the first coupling output 19 have an identical speed reduction relative to the first input 17.

In an analogous manner, the second transfer case 14 allows the second axle output 21 to be coupled with or uncoupled from the second electric motor 15 by way of a second axle output coupling element (not shown in FIG. 1) and allows the second coupling output 22 to be coupled with or uncoupled from the second electric motor 15 by way of a second coupling output coupling element (not shown in FIG. 1). According to the example, the second coupling output coupling element is arranged in the housing of the second transfer case 14.

According to the example, the second axle output 21 and the second coupling output 22 have an identical speed reduction relative to the second input 20. This speed reduction is additionally identical, according to the example, with the speed reduction of the first coupling output 19 or of the first axle output 18 relative to the first input 17.

Because the first coupling output 19 and the second coupling output 22 can be uncoupled from the first electric motor 12 and the second electric motor 15, respectively, the coupling shaft 23 can be switched without drive. The coupling shaft 23 thus does not generate any drag torque during operation of the first transfer case 11 and of the second transfer case 14 when the first and second coupling output coupling elements are detached.

If, however, the first and second coupling output coupling elements are closed, drive power can, if required, be guided from the first electric motor 12 to the second transfer case 14 and, conversely, from the second electric motor 15 to the first transfer case 11. Thus, if excessive slip of the first axle is detected, for example, the first axle 13 can be locked by way of the first axle output coupling element. The drive power of the first electric motor 12 is then provided for driving the second axle 16 by way of the coupling shaft 23 and the second transfer case 14.

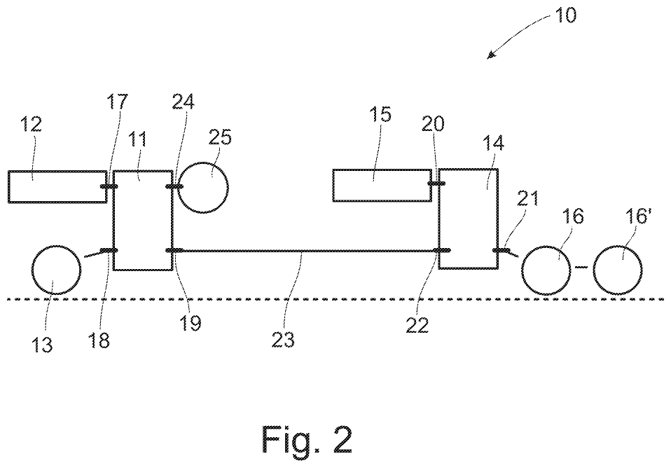

FIG. 2 shows by way of example and schematically a further possible embodiment of an electrically operable drive train 10 according to the invention. The drive train 10 of FIG. 2 differs from the drive train 10 of FIG. 1 in that the second transfer case 14 has two associated second axles 16, 16′, both of which are driven by way of the second axle output 21.

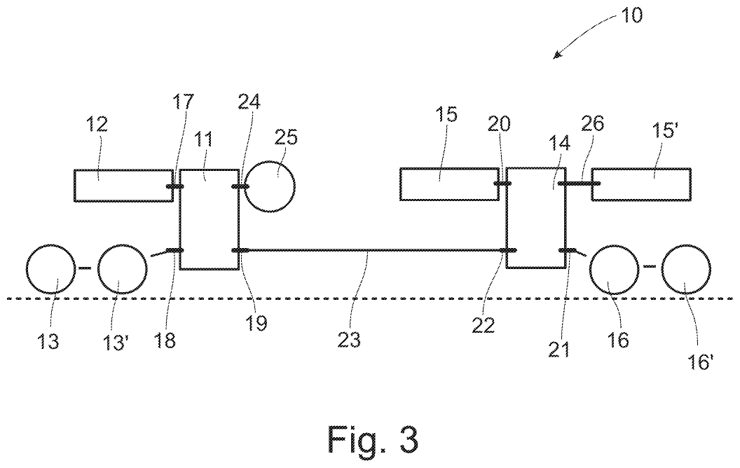

FIG. 3 shows by way of example and schematically yet a further possible embodiment of an electrically operable drive train 10 according to the invention. The drive train 10 of FIG. 3 differs from the drive train 10 of FIG. 2 in that the first transfer case 11 also has two associated first axles 13, 13′, both of which are correspondingly driven by way of the first axle output 18.

The drive train 10 of FIG. 3 additionally has a second power take-off 26 at the second transfer case, wherein the second power take-off 26 can be coupled with the second electric motor 15 by way of a second power take-off coupling element (not shown in FIG. 3). According to the example, however, there is connected in a driving manner to the second power take-off 26 not a secondary consumer 25 but instead an additional second electric motor 15′, which is able to input additional drive power into the second transfer case 14 by way of the second power take-off 26. The second power take-off 26 is thus used according to the example as an additional input into the second transfer case 14.

### REFERENCE SIGNS

10 drive train
11 first transfer case
12 first electric motor
13, 13′ first axle
14 second transfer case
15, 15′ second electric motor
16, 16′ second axle
17 first input
17′ knuckle arm, steering linkage
17″ steering arm, steering linkage
18 first axle output
19 first coupling output
20 second input
21 second axle output
22 second coupling output
23 coupling shaft
24 first power take-off
25 secondary consumer
26 second power take-off

1. An electrically operable drive train (10), comprising:
a first transfer case (11) having a first input (17), a first axle output (18) and a first coupling output (19) and a power take-off (24);
a first electric motor (12);
a first axle (13, 13′);
a second transfer case (14) having a second input (20), a second axle output (21) and a second coupling output (22);
a second electric motor (15, 15′) and;
a second axle (16, 16);
wherein the first coupling output (19) is configured to be coupled with the second coupling output (22) by way of a coupling shaft (23).

2. The drive train (10) as claimed in claim 1,
wherein the first axle output (18) is configured to be coupled with the first electric motor (12) by way of a first axle output coupling element,
the first power take-off (24) is configured to be coupled with the first electric motor (12) by way of a first power take-off coupling element,
the first coupling output (19) is configured to be coupled with the first electric motor (12) by way of a first coupling output coupling element,
the second axle output (21) is configured to be coupled with the second electric motor (15, 15′) by way of a second axle output coupling element, and
the second coupling output (22) is configured to be coupled with the second electric motor (15, 15′) by way of a second coupling output coupling element.

3. The drive train (10) as claimed in claim 1,
wherein the second transfer case (14) further has a second power take-off (26) configured to be coupled with the second electric motor (15, 15′) by way of a second power take-off coupling element.

4. The drive train (10) as claimed in claim 3,
wherein the first coupling output coupling element is arranged in the first transfer case (11) and the second coupling output coupling element is arranged in the second transfer case (14).

5. The drive train (10) as claimed in claim 1,
wherein the first axle output (18) and the first coupling output (19) have an identical speed reduction relative to the first input (17), and
the second axle output (21) and the second coupling output (22) have the same identical speed reduction relative to the second input (20).

6. The drive train (10) as claimed in claim 1,
wherein the first transfer case (11) has a plurality of associated first axles (13, 13′).

7. The drive train (10) as claimed in claim 1,
wherein the second transfer case (14) has a plurality of associated second axles (16, 16′).

8. The drive train (10) as claimed in claim 1,
wherein the first power take-off (24) is connected in a driving manner to an additional first electric motor.

9. The drive train (10) as claimed in claim 1,
wherein the second power take-off (26) is connected in a driving manner to an additional second electric motor (15′).

10. A vehicle comprising the drive train of claim 1.

11. The vehicle of claim 10, wherein:
the first axle output (18) is configured to be coupled with the first electric motor (12) by way of a first axle output coupling element;
the first power take-off (24) is configured to be coupled with the first electric motor (12) by way of a first power take-off coupling element;
the first coupling output (19) is configured to be coupled with the first electric motor (12) by way of a first coupling output coupling element;
the second axle output (21) is configured to be coupled with the second electric motor (15, 15′) by way of a second axle output coupling element; and
the second coupling output (22) is configured to be coupled with the second electric motor (15, 15′) by way of a second coupling output coupling element.

12. The vehicle of claim 10, wherein the second transfer case (14) further has a second power take-off (26) configured to be coupled with the second electric motor (15, 15′) by way of a second power take-off coupling element.

13. The vehicle of claim 12,
wherein the first coupling output coupling element is arranged in the first transfer case (11) and the second coupling output coupling element is arranged in the second transfer case (14).

14. The vehicle of claim 10,
wherein the first axle output (18) and the first coupling output (19) have an identical speed reduction relative to the first input (17), and
the second axle output (21) and the second coupling output (22) have the same identical speed reduction relative to the second input (20).

15. The vehicle of claim 14, wherein the first transfer case (11) has a plurality of associated first axles (13, 13′).

16. The vehicle of claim 15, wherein the second transfer case (14) has a plurality of associated second axles (16, 16′).

17. The vehicle of claim 16, wherein the first power take-off (24) is connected in a driving manner to an additional first electric motor.

18. The vehicle of claim 17, wherein the second power take-off (26) is connected in a driving manner to an additional second electric motor (15′).
